(19) United States
(12) Patent Application Publication
(10) Pub. No.: US 2026/0200513 A1
(43) Pub. Date: Jul. 16, 2026

(54) System and Method of Priority Mover Order in an Independent Cart System

(71) Applicant: Rockwell Automation Technologies, Inc., Mayfield Heights, OH (US)

(72) Inventors: Zoë Le Garrec, Boston, MA (US); Yuhong Huang, Acton, MA (US)

(21) Appl. No.: 19/024,451

(22) Filed: Jan. 16, 2025

(51) Int. Cl. B61L 27/16; B65G 54/02

(52) U.S. Cl. CPC B61L 27/16; B65G 54/02

(57) ABSTRACT

A vehicle route for an independent cart system is dynamically modified by assigning a first priority level to a first mover and identifying a first destination for the first mover. The first mover is located on a first track segment, and the first destination is located on a second track segment. The first priority level and the first destination are transmitted from a first segment controller for the first track segment to a second segment controller for a track segment present between the first and second track segments. The first priority level is received at the second segment controller and compared to a second priority level for a second mover. When the first priority level is greater than the second priority level, the second mover is commanded to transition to a track segment other than the track segments present between the first and second track segments.

### BACKGROUND INFORMATION

The subject matter disclosed herein relates to a system and method for adapting routes for vehicles in an independent cart system in real time. More specifically, a vehicle assigned to a high priority level may communicate with other vehicles and with track segments in the independent cart system to provide a clear path of travel for the high priority vehicle.

As is known to those skilled in the art, motion control systems utilizing independent cart technology employ a linear drive system embedded within a track and multiple vehicles, also referred to as “movers” or carts, that are propelled along the track via the linear drive system. Movers and linear drive systems can be used in a wide variety of processes (e.g. packaging, manufacturing, and machining) and can provide an advantage over conventional conveyor belt systems with enhanced flexibility, extremely high-speed movement, and mechanical simplicity. The independently controlled movers or carts are each supported on a track for motion along the track.

Historically, independent cart systems were configured to provide a single, closed path over which vehicles would travel. The vehicles would receive a payload at a first location along the path. Additional actions would be performed to the payload or further payload added as the vehicle traveled between the first location and a second location along the path. At the second location, the payload would be removed, and the vehicle would return to the first location via a return route.

However, applications in which independent cart systems are deployed have evolved. New applications include, for example, fulfillment centers, inventory management between a manufacturing facility and a warehouse, or automated delivery between stations in a laboratory testing environment. Track layouts include multiple routes, parallel paths, switches, an increasing number of vehicles, and varying payloads that may need to be conveyed by the independent cart system. The independent cart system may receive a request for a payload to be transported between a first location and a second location. When the request is received, a vehicle is identified to transport the payload and a route for the vehicle is determined. As the vehicle travels along the route, however, other vehicles in the system are similarly commanded to travel between two locations. As the multiple vehicles travel through the independent cart system, multiple vehicles may be commanded to travel along a common track segment causing congestion on that track segment.

In some applications, a payload assigned to one vehicle may have a high priority assigned. A manufacturing facility, for example, may require parts be installed in a particular order. A station earlier in the manufacturing process may be low on parts and production will be halted if the station runs out of parts. A vehicle delivering parts to that station may need to arrive at the station prior to other traffic along the independent cart system. In a laboratory testing environment, a number of patient samples may be present for testing. Samples are loaded onto vehicles and delivered to the appropriate stations generally in a first-in, first-out (FIFO) format. However, a sample, for example, from a patient in surgery or in an emergency room may need immediate testing and take priority over other patient samples already in the testing environment. Congestion along one or more track segments in the independent cart system may, in the first example, cause the system to shut down while the station waits for parts or, in the second example, cause a delay in testing of an important sample.

Thus, it would be desirable to provide a system and method for clearing congestion along a route of vehicle in real-time for an independent cart system.

### BRIEF DESCRIPTION

According to one embodiment of the invention, a method for dynamic adaptation of a

vehicle route in an independent cart system assigns a first priority level to a first mover in the independent cart system and identifies a first destination for the first mover. The first mover is located on a first track segment, the first destination is located on a second track segment, and multiple track segments are present between the first track segment and the second track segment. The first priority level and the first destination are transmitted from a first segment controller for the first track segment to a second segment controller for at least one of the track segments present between the first track segment and the second track segment. The first priority level is received at the second segment controller for a corresponding track segment on which a second mover is located and compared to a second priority level for the second mover at the second segment controller. When the first priority level is greater than the second priority level, the second mover is commanded to transition to at least one track segment other than the track segments present between the first track segment and the second track segment.

According to another embodiment of the invention, a system for dynamic adaptation of a vehicle path in an independent cart system includes a first and a second track segment and a first and a second mover. The first and second track segments are selected from multiple track segments which define a track for the independent cart system. The first mover is present on the first track segment, and the second mover is present on the second track segment. The first track segment includes a first segment controller configured to control motion of the first mover while it is present on the first track segment, and the second track segment includes a second segment controller configured to control motion of the second mover while it is present on the second track segment. The second segment controller is in communication with the first segment controller. The first segment controller has a first priority and a first destination for the first mover. The first segment controller transmits the first priority and the first destination to the second segment controller, and the second segment controller compares the first priority to a second priority for the second mover. When the first priority level is greater than the second priority level, the second segment controller modifies an existing route commanded for the second mover to allow a clear route for the first mover to travel to the first destination.

According to still another embodiment of the invention, a method for dynamic adaptation of a vehicle route in an independent cart system assigns a first priority level to a first mover in the independent cart system and generates a first route for the first mover to reach a destination. The first route includes multiple track segments for the independent cart system along which the first mover will travel. The first route and the first priority level are provided to a first segment controller for the track segment on which the first mover is located, and the first segment controller transmits the first priority level and the first route to at least one additional segment controller for another track segment along the first route. The first priority level for the first mover is received at a second segment controller corresponding to a track segment on which a second mover is located. The first priority level is compared to a second priority level for the second mover at the second segment controller. A second route for the second mover is compared to the first route with the second segment controller when the first priority level is greater than the second priority level, and the second route is adjusted to allow the first mover to travel along the first route when the first priority level is greater than the second priority level and when the second route interferes with the first route.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is a schematic representation of an exemplary control system for an independent cart system according to one embodiment of the invention;

FIG. 2 is a perspective view of one embodiment of a mover configured to travel along the track of FIG. 1;

FIG. 3 is a front elevational view of the mover of FIG. 2;

FIG. 4 is a side elevational view of the mover of FIG. 2;

FIG. 5 is a top plan view of the mover of FIG. 2;

FIG. 6 is a sectional view of one embodiment of a mover and track segment included in the linear drive system taken at 6-6 of FIG. 1;

FIG. 7 is a perspective view of one embodiment of a magnet array used within the mover of FIG. 6;

FIG. 8 is a partial top cutaway view of the mover and track segment of FIG. 1;

FIG. 9 is a block diagram representation of the exemplary control system of FIG. 1;

FIG. 10 is a representation of one embodiment of a mover worksheet to be transmitted between segment controllers as a mover travels within the independent cart system;

FIG. 11 is a top plan view of an exemplary switch track segment;

FIG. 12 is a top plan view of a portion of an exemplary track illustrating different options for communication between segment controllers;

FIG. 13 is a top plan view of a portion of an exemplary track illustrating a first mover commanded to a destination with multiple additional movers travelling along the portion of the exemplary track;

FIG. 14 is a top plan view of a portion of an exemplary track illustrating a priority lane and a secondary lane in parallel to the priority lane;

FIG. 15 is a top plan view of a portion of an exemplary track illustrating a looping main path with multiple side paths;

FIG. 16 is a top plan view of a portion of an exemplary track illustrating a buffer zone along a straight track;

FIG. 17 is a top plan view of a portion of an exemplary track illustrating a bypass zone along a straight track; and

FIG. 18 is a top plan view of a portion of an exemplary track illustrating a rotary track segment configured to selectively deliver movers from one incoming path to multiple exit paths.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are

explained more fully with reference to the non-limiting embodiments described in detail in the following description.

The subject matter disclosed herein describes a system and method for clearing congestion along a route of vehicle in real-time for an independent cart system. The independent cart system may include a fleet controller configured to monitor the present location and configuration of each vehicle in the independent cart system. Different vehicles may, for example, include different fixtures or attachments for receiving payload. Different vehicles may have different sizes, capacities, and performance characteristics. The fleet controller receives a request for a vehicle to transport a payload via the independent cart system and identifies a suitable vehicle. The vehicle may be selected, for example, based on its proximity to the requested location, the required payload to transport, the rate at which the mover may transport the required payload, or other similar characteristics. Once a vehicle is selected, the fleet controller transmits required information to the segment controller, corresponding to a track segment on which the vehicle is located, to complete the request. After receiving the initial information, the segment controllers assume responsibility for completing the request.

As the number of requests for vehicles within the independent cart system increases, multiple vehicles may be required to travel along the same sections of a track. Typically, vehicles will travel along the section of track in the order of arrival. However, in some instances, it may be necessary for a vehicle with higher priority to transit a section of track prior to other vehicles. Each segment controller is in communication with additional segment controllers in track segments adjacent to a track segment for the first segment controller. The segment controller on which a mover is located is configured to transmit a message to one or more additional segment controllers along a route or in a direction the vehicle will travel. The message includes a priority level for the vehicle. Each segment controller may compare the priority level for the vehicle which will be arriving at the corresponding track segment for the segment controller to a priority level of a vehicle, or vehicles, already present on the track segment. If the priority level of the inbound vehicle is greater than the priority level of vehicles already present on the track segment, the segment controller is configured to modify route commands for the vehicles already present on the track segment to clear the route for the inbound vehicle.

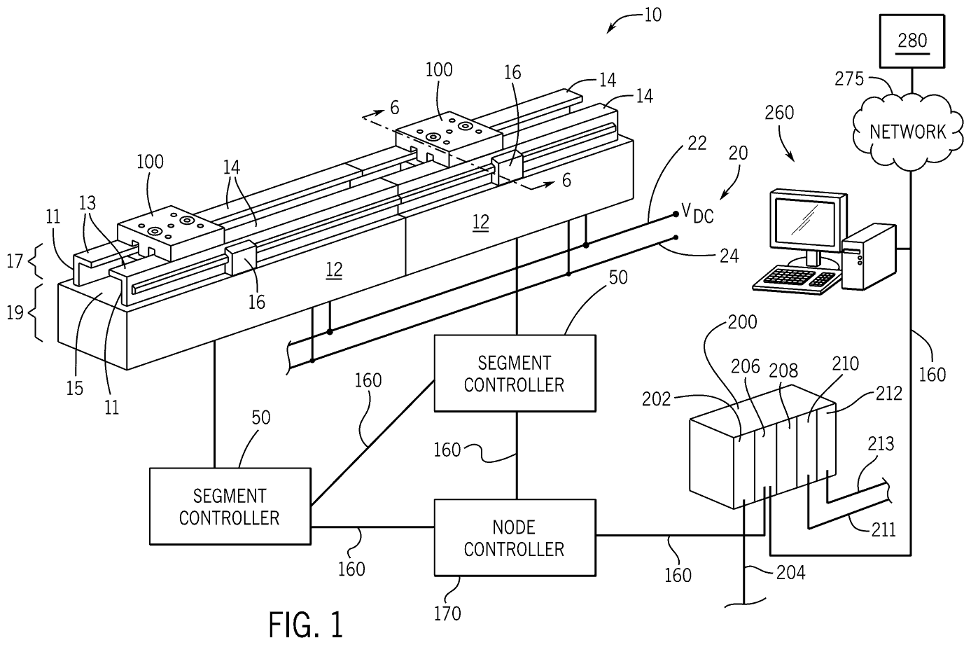

Turning initially to FIG. 1, an exemplary transport system for moving articles or products includes a track 10 made up of multiple segments 12. According to the illustrated embodiment, multiple segments 12 are joined end-to-end to define the overall track configuration. The illustrated segments 12 are both straight segments having generally the same length. It is understood that track segments of various sizes, lengths, and shapes may be connected together to form the track 10 without deviating from the scope of the invention. The track 10 is illustrated in a horizontal plane. For convenience, the horizontal orientation of the track 10 shown in FIG. 1 will be discussed herein. Terms such as upper, lower, inner, and outer will be used with respect to the illustrated track orientation. These terms are relational with respect to the illustrated track and are not intended to be limiting. It is understood that the track may be installed in different orientations, such as sloped or vertical, and include different shaped segments including, but not limited to, straight segments, inward bends, outward bends, up slopes, down slopes, right-hand switches, left-hand switches, and various combinations thereof. The width of the track 10 may be greater in either the horizontal or vertical direction according to application requirements. The movers 100 will travel along the track and take various orientations according to the configuration of the track 10 and the relationships discussed herein may vary accordingly.

According to the illustrated embodiment, each track segment 12 includes an upper portion 17 and a lower portion 19. The upper portion 17 is configured to carry the movers 100 and the lower portion 19 is configured to house the control elements. As illustrated, the upper portion 17 includes a pair of rails 14 extending longitudinally along the upper portion 17 of each track segment 12 and defining a channel 15 between the two rails. Clamps 16 affix to the sides of the rails 14 and secure the rails 14 to the lower portion 19 of the track segment 12. Each rail 14 is generally L-shaped with a side segment 11 extending in a generally orthogonal direction upward from the lower portion 19 of the track segment 12, and a top segment 13 extending inward toward the opposite rail 14. The top segment 13 extends generally parallel to the lower portion 19 of the track segment 12 and generally orthogonal to the side segment 11 of the rail 14. Each top segment 13 extends toward the opposite rail 14 for only a portion of the distance between rails 14, leaving a gap between the two rails 14. The gap and the channel 15 between rails 14 define a guideway along which the movers 100 travel.

According to one embodiment, the surfaces of the rails 14 and of the channel 15 are planar surfaces made of a low friction material along which movers 100 may slide. The contacting surfaces of the movers 100 may also be planar and made of a low friction material. It is contemplated that the surface may be, for example, nylon, Teflon®, aluminum, stainless steel and the like. According to one aspect of the invention, the hardness of the surfaces on the track segment 12 are greater than the contacting surface of the movers 100 such that the contacting surfaces of the movers 100 wear faster than the surface of the track segment 12. It is further contemplated that the contacting surfaces of the movers 100 may be removably mounted to the mover 100 such that they may be replaced if the wear exceeds a predefined amount. According to still other embodiments, the movers 100 may include low-friction rollers to engage the surfaces of the track segment 12. Optionally, the surfaces of the channel 15 may include different cross-sectional forms with the mover 100 including complementary sectional forms. Various other combinations of shapes and construction of the track segment 12 and mover 100 may be utilized without deviating from the scope of the invention.

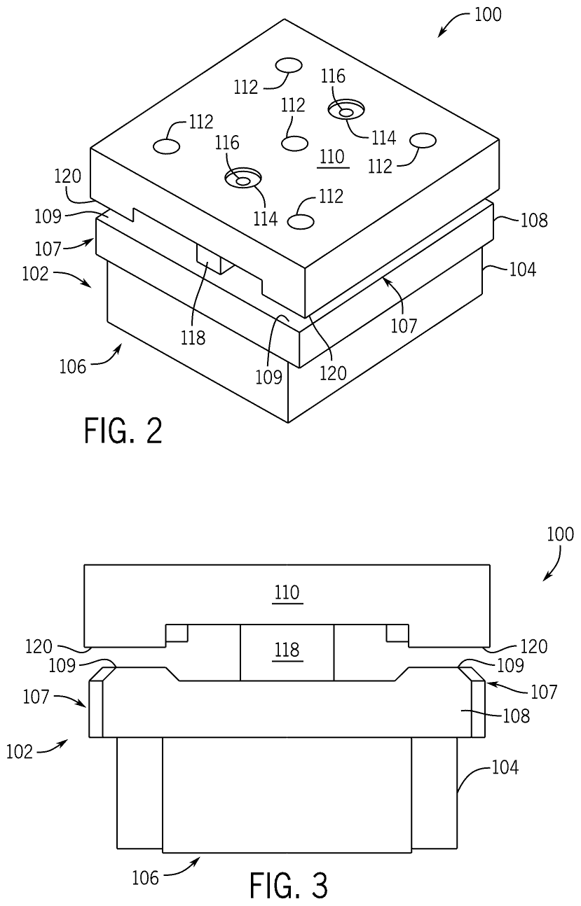

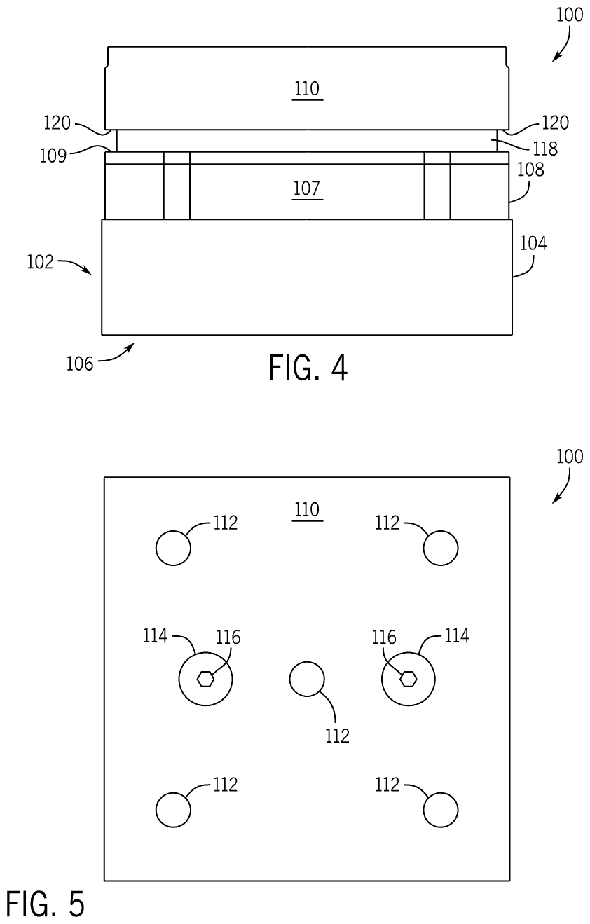

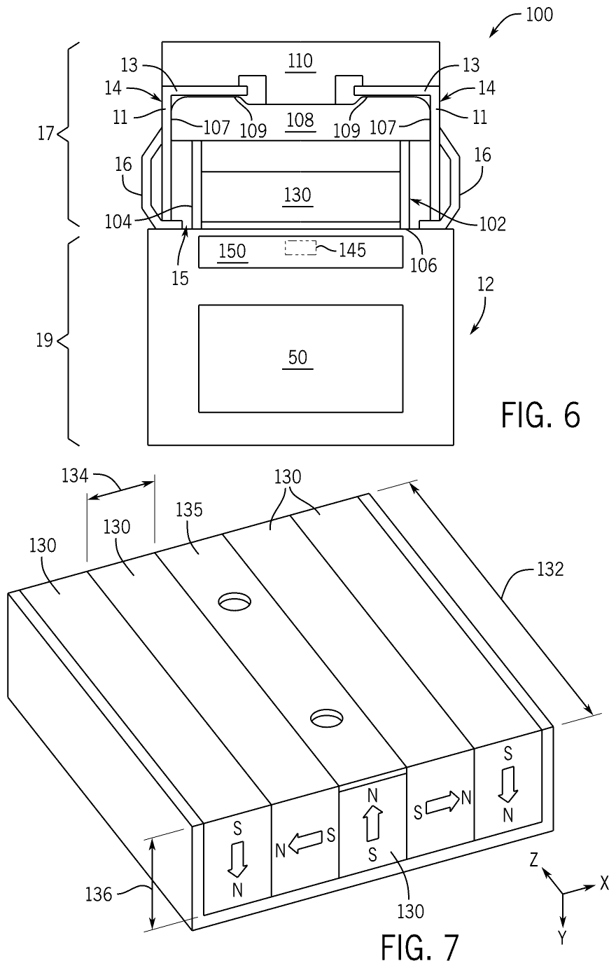

Turning next to FIGS. 2-5, one embodiment of the mover 100 is configured to slide along the channel 15 as it is propelled by a linear drive system. The mover 100 includes a body 102 configured to fit within the channel 15. The body 102 includes a lower portion 104, configured to hold magnets 130 (see also FIG. 6), and an upper portion 108, configured to engage the rails 14. The lower portion has a lower surface 106 to slide along the bottom surface of the channel 15. The upper portion 108 includes side contacting surfaces 107 which slide along an interior surface of the side segments 11 of the rails 14 and upper contacting surfaces 109 which slide along an interior surface of the top segments 13 of the rails 14. The mover 100 also includes a platform 110 mounted to the body 102 of the mover. An upper surface of the platform 110 includes multiple threaded openings 112 to which a fixture, or workpiece, may be mounted. Various workpieces, clips, fixtures, and the like may be mounted on the top of each platform 110 for engagement with a payload to be carried along the track by the mover 100 according to an application's requirements. The platform 110 also includes a pair of openings 114 through which a threaded fastener 116 such as a bolt may be used to secure the platform 110 to the body 102 of the mover 100. A central guide portion 118 of the platform 110 extends downward toward the body 102 of the mover 100. The central guide portion 118 has a width less than the gap between the two rails 14 and fits within the gap between rails when the mover 100 is mounted on the track. The central guide portion 118 also extends further than lower contacting surfaces 120 on the platform 110 creating a gap between the upper contacting surfaces 109 of the body 102 and the lower contacting surfaces 120 of the platform 110 generally equal to the width of the top segment 13 of the rails 14 such that the lower contacting surfaces 120 of the platform 110 slide along an exterior surface of the top segments 13 of the rails. According to the illustrated embodiment, the platform 110 is generally square and has a sectional area similar to the sectional area of the body 102 as viewed from the top of the mover 100. It is contemplated that platforms 110, or attachments, of various shapes may be secured to the body 102.

The mover 100 is carried along the track 10 by a linear drive system. The linear drive system is incorporated in part on each mover 100 and in part within each track segment 12. One or more drive magnets 130 are mounted to each mover 100. With reference to FIG. 6, the drive magnets 130 are arranged in a block on the lower surface of each mover. With reference also to FIG. 7, the illustrated embodiment includes five drive magnets 130 placed adjacent to each other in a Halbach array to define the block of magnets. Each magnet 130 has a length 132 extending in the z-axis, a width 134 extending in the x-axis, and a height 136 extending in the y-axis. From left-to-right in FIG. 7, a first drive magnet 130 has a north pole oriented along a y-axis toward the track when the mover 100 is mounted on the track. A second drive magnet 130 has a north pole oriented along an x-axis, and a third drive magnet 130 has a north pole oriented along the y-axis away from the track. A fourth drive magnet 130 has a north pole oriented along the x-axis in a direction opposite the second magnet, and a fifth drive magnet 130 has the north pole again oriented toward the track along the y-axis. As also illustrated, an orientation of the magnetic field is illustrated by the arrow pointing from the south pole toward the north pole. For movers 100 having a greater length, this rotation of the orientation for the drive magnets 130 may continue along the length of the mover 100. The Halbach array configuration has an advantage of cancelling magnetic flux tending to extend upward into the rest of the mover 100 while increasing the magnetic flux tending to extend downward toward the track for interaction with the linear drive system. The illustrated embodiment for the arrangement of drive magnets 130 is not intended to be limiting. Various other configurations of the drive magnets 130 may be utilized as non-illustrated embodiments of the invention.

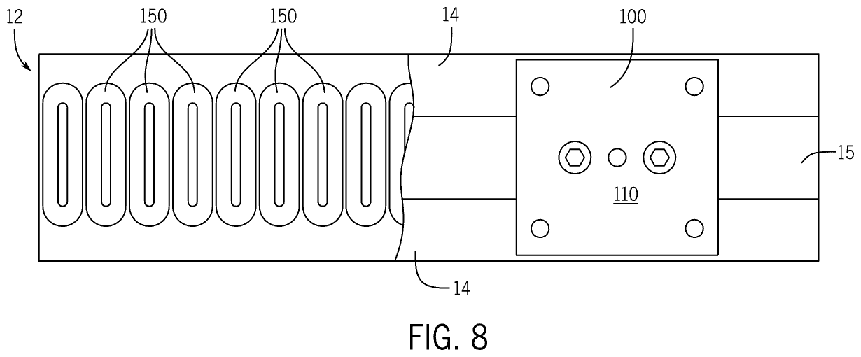

The linear drive system further includes a series of coils 150 spaced along the length of the track segment 12. With reference also to FIG. 8, the coils 150 may be positioned within a housing for the lower portion 19 of the track segment 12 and below the surface of the channel 15. The coils 150 are energized sequentially according to the configuration of the drive magnets 130 present on the movers 100. The sequential energization of the coils 150 generates a moving electromagnetic field that interacts with the magnetic field of the drive magnets 130 to propel each mover 100 along the track segment 12.

A segment controller 50 is provided within each track segment 12 to control the linear drive system and to achieve the desired motion of each mover 100 along the track segment 12. Although illustrated in FIG. 1 as blocks external to the track segments 12, the arrangement is to facilitate illustration of interconnects between controllers. As shown in FIG. 6, it is contemplated that each segment controller 50 may be mounted in the lower portion 19 of the track segment 12. Each segment controller 50 is in communication with a node controller 170 which is, in turn, in communication with an industrial controller 200. The industrial controller may be, for example, a programmable logic controller (PLC) configured to control elements of a process line stationed along the track 10. The process line may be configured, for example, to fill and label boxes, bottles, or other containers loaded onto or held by the movers 100 as they travel along the line. In other embodiments, robotic assembly stations may perform various assembly and/or machining tasks on workpieces carried along by the movers 100. The exemplary industrial controller 200 includes: a power supply 202 with a power cable 204 connected, for example, to a utility power supply; a communication module 206 connected by a network medium 160 to the node controller 170; a processor module 208; an input module 210 receiving input signals 211 from sensors or other devices along the process line; and an output module 212 transmitting control signals 213 to controlled devices, actuators, and the like along the process line. The processor module 208 may identify when a mover 100 is required at a particular location and may monitor sensors, such as proximity sensors, position switches, or the like to verify that the mover 100 is at a desired location. The processor module 208 transmits the desired locations of each mover 100 to a node controller 170 where the node controller 170 operates to generate commands for each segment controller 50.

As further illustrated in FIG. 1, the independent cart system may include a local, edge controller 260, a remote application executing and hosted in a data processing center 280, or a combination thereof. The edge controller 260 is connected to the industrial controller 200 via the network medium 160. If a remote application is being used, the edge controller 260 and/or the industrial controller 200 is connected to the data processing center 280 via a suitable network 275. The network 275 may include a local intranet, the Internet, or a combination thereof. The network 275 may be wired or wireless, including Wi-Fi or cellular communications over a single channel or multiple channels.

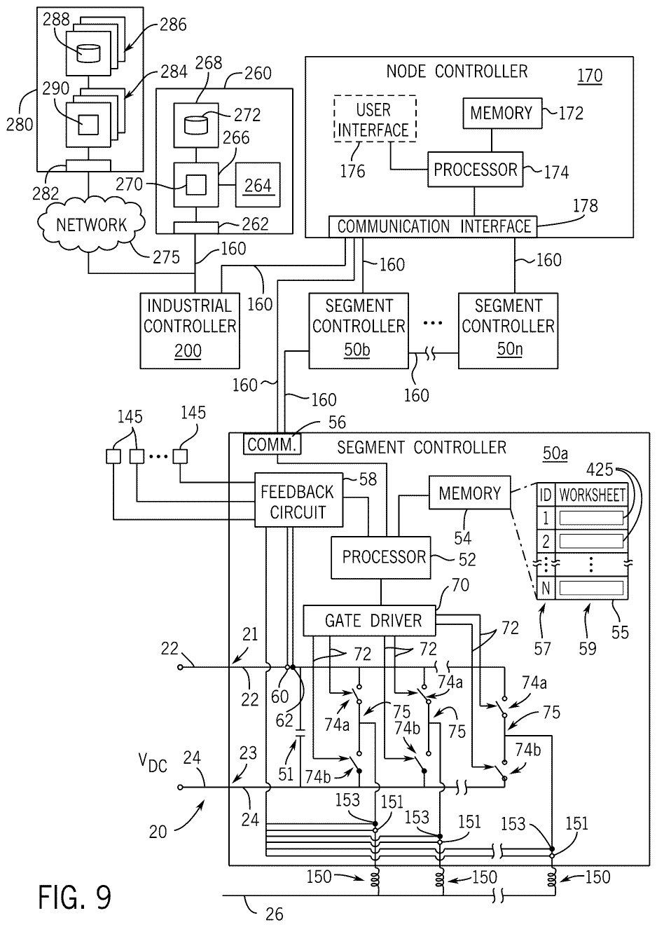

With reference also to FIG. 9, the edge controller 260 includes a communication interface 262 to connect to the network medium 160. The communication interface 262 is configured to transmit and receive data packets between the network and a processor 266 present in the edge controller 260. The edge controller 260 includes the processor 266 and memory 268. It is contemplated that the processor 266 and memory 268 may each be a single electronic device or formed from multiple devices. The processor 266 may be a microprocessor. Optionally, the processor 266 and/or at least a portion of the memory 268 may be integrated on a field programmable gate array (FPGA) or an application specific integrated circuit (ASIC). The memory 268 may include volatile memory, non-volatile memory, or a combination thereof. The memory 268 may further include fixed or removable storage medium, such as a magnetic or solid-state hard disk drive, a fixed or removable memory card, an optical drive, or a combination thereof. An optional user interface 264 may be provided for an operator to interface with the edge controller 260. The user interface 264 may include a monitor, keyboard, mouse, trackball, touch pad, touch screen, or any other suitable device to receive input from or display data to a user. Optionally, the edge controller 260 may be accessed via the network 275 from a remote device.

The edge controller 260 is configured to execute one or more applications 270 on the processor. The edge controller 260 may execute independently or in combination with the data processing center 280. The edge controller 260 may serve as a fleet controller for the independent cart system or be in communication with another controller serving as a dedicated fleet controller. The edge controller 260 may also execute a machine learning model corresponding to the independent cart system and to the operating conditions along the track for the independent cart system. The memory 268 is configured to store a database 272 including rules for the machine learning model, a history of reference and/or feedback signals from the independent cart system, and data regarding routes travelled within the independent cart system including, but not limited to, a history of routes travelled, a time of day routes are travelled, and a length of time a mover takes to traverse a route. The machine learning model uses the historical data from the feedback signals and/or rules stored within the database 272 to identify trends or other conditions in the traffic flow for the independent cart system. The edge controller 260 may use the identified trends to generate a first route for a mover 100. The first route for each mover is transmitted to a segment controller 50 for a track segment 12 on which the mover 100 is located to begin controlling operation of the mover.

Similarly, a data processing center 280 includes a communication interface 282. The communication interface 282 provides access to the network 275 and transmits data packets between the data processing center 280 and the industrial controller 200 or the edge controller 260. Although illustrated as a single data processing center, the data processing center may be distributed among multiple facilities providing Infrastructure as a Service (IaaS) or Platform as a Service (PaaS), where the IaaS or PaaS host the application executing thereon as Software as a Service (SaaS). The data processing center 280 further includes multiple processing units 284 and multiple storage units 286. One or more of the processing units 284 is configured to execute applications 290 such as the machine learning model. The applications 290 are in communication with the storage units 286 to store data to and read data from one or more databases 288 stored on one or more storage units 286.

With reference also to FIG. 9, the node controller 170 includes a processor 174 and a memory device 172. It is contemplated that the processor 174 and memory device 172 may each be a single electronic device or formed from multiple devices. The processor 174 may be a microprocessor. Optionally, the processor 174 and/or the memory device 172 may be integrated on a field programmable gate array (FPGA) or an application specific integrated circuit (ASIC). The memory device 172 may include volatile memory, non-volatile memory, or a combination thereof. An optional user interface 176 may be provided for an operator to configure the node controller 170 and to load or configure desired motion profiles for the movers 100 on the node controller 170. Optionally, the configuration may be performed via a remote device connected via a network and a communication interface 178 to the node controller 170. It is contemplated that the node controller 170 and user interface 176 may be a single device, such as a laptop, notebook, tablet or other mobile computing device. Optionally, the user interface 176 may include one or more separate devices such as a keyboard, mouse, display, touchscreen, interface port, removable storage medium or medium reader and the like for receiving information from and displaying information to a user. Optionally, the node controller 170 and user interface may be an industrial computer mounted within a control cabinet and configured to withstand harsh operating environments. It is contemplated that still other combinations of computing devices and peripherals as would be understood in the art may be utilized or incorporated into the node controller 170 and user interface 176 without deviating from the scope of the invention.

The node controller 170 includes one or more programs stored in the memory device 172 for execution by the processor 174. The node controller 170 receives a desired position for a mover from the industrial controller 200 and determines one or more motion profiles for the movers 100 to follow along the track 10. A program executing on the processor 174 is in communication with each segment controller 50 on each track segment via a network medium 160. The node controller 170 may transfer a desired motion profile to each segment controller 50. Optionally, the node controller 170 may be configured to transfer the information from the industrial controller 200 identifying one or more desired movers 100 to be positioned at or moved along the track segment 12, and the segment controller 50 may determine the appropriate motion profile for each mover 100. Various features of the present application will be discussed herein as being executed within the segment controller 50, the industrial controller 200, and the node controller 170. As illustrated in FIGS. 1 and 9, these controllers are interconnected by the network medium 160. According to other, non-illustrated embodiments of the invention, various features discussed herein as implemented on one of the controllers 50, 200, 170 may be implemented on another controller with communication via the network medium 160 transmitting data required to perform the functions between the various controllers.

A position feedback system provides knowledge of the location of each mover 100 along the length of the track segment 12 to the segment controller 50. According to one embodiment of the invention, the position feedback system includes one or more position magnets mounted to the mover 100. According to another embodiment of the invention, illustrated in FIG. 6, the position feedback system utilizes the drive magnets 130 as position magnets. Position sensors 145 are positioned along the track segment 12 at a location suitable to detect the magnetic field generated by the drive magnets 130. According to the illustrated embodiment, the position sensors 145 are located below or interspersed with the coils 150. The sensors 145 are positioned such that each of the drive magnets 130 are proximate to the sensor as the mover 100 passes each sensor 145. The sensors 145 are a suitable magnetic field detector including, for example, a Hall Effect sensor, a magneto-diode, an anisotropic magnetoresistive (AMR) device, a giant magnetoresistive (GMR) device, a tunnel magnetoresistance (TMR) device, fluxgate sensor, or other microelectromechanical (MEMS) device configured to generate an electrical signal corresponding to the presence of a magnetic field. The magnetic field sensor 145 outputs a feedback signal provided to the segment controller 50 for the corresponding track segment 12 on which the sensor 145 is mounted. The position sensors 145 are spaced apart along the length of the track. According to one aspect of the invention, the position sensors 145 are spaced apart such that adjacent position sensors 145 generate a feedback signal which is offset from each other by ninety electrical degrees (90°). Multiple position sensors 145 are, therefore, generating feedback signals in tandem for a single mover 100 as the mover is travelling along the track 10. The feedback signals from each position sensor 145 are provided to a feedback circuit 58 which, in turn, provides a signal to the processor 52 corresponding to the magnet 130 passing the sensor 145.

The segment controller 50 also includes a communication interface 56 that receives communications from the node controller 170 and/or from adjacent segment controllers 50. The communication interface 56 extracts data from the message packets on the industrial network and passes the data to a processor 52 executing in the segment controller 50. The processor may be a microprocessor. Optionally, the processor 52 and/or a memory device 54 within the segment controller 50 may be integrated on a field programmable gate array (FPGA) or an application specific integrated circuit (ASIC). It is contemplated that the processor 52 and memory device 54 may each be a single electronic device or formed from multiple devices. The memory device 54 may include volatile memory, non-volatile memory, or a combination thereof. The segment controller 50 receives the motion profile or desired motion of the movers 100 and utilizes the motion commands to control movers 100 along the track segment 12 controlled by that segment controller 50.

Each segment controller 50 generates switching signals to generate a desired current and/or voltage at each coil 150 in the track segment 12 to achieve the desired motion of the movers 100. The switching signals 72 control operation of switching devices 74 for the segment controller 50. According to the illustrated embodiment, the segment controller 50 includes a dedicated gate driver module 70 which receives command signals from the processor 52, such as a desired voltage and/or current to be generated in each coil 150, and generates the switching signals 72. Optionally, the processor 52 may incorporate the functions of the gate driver module 70 and directly generate the switching signals 72. The switching devices 74 may be a solid-state device that is activated by the switching signal, including, but not limited to, transistors, thyristors, or silicon-controlled rectifiers.

According to the illustrated embodiment, the track receives power from a distributed DC voltage. With reference again to FIG. 1, a DC bus 20 receives a DC voltage, VDC, from a DC supply and conducts the DC voltage to each track segment 12. The illustrated DC bus 20 includes two voltage rails 22, 24 across which the DC voltage is present. The DC supply may include, for example, a rectifier front end configured to receive a single or multi-phase AC voltage at an input and to convert the AC voltage to the DC voltage. It is contemplated that the rectifier section may be passive, including a diode bridge or, active, including, for example, transistors, thyristors, silicon-controlled rectifiers, or other controlled solid-state devices. Although illustrated external to the track segment 12, it is contemplated that the DC bus 20 would extend within the lower portion 19 of the track segment. Each track segment 12 includes connectors to which either the DC supply or another track segment may be connected such that the DC bus 20 may extend for the length of the track 10. Optionally, each track segment 12 may be configured to include a rectifier section (not shown) and receive an AC voltage input. The rectifier section in each track segment 12 may convert the AC voltage to a DC voltage utilized by the corresponding track segment.

The DC voltage from the DC bus 20 is provided at the input terminals 21, 23 to a power section for the segment controller. A first voltage potential is present at the first input terminal 21 and a second voltage potential is present at the second input terminal 23. The DC bus extends into the power section defining a positive rail 22 and a negative rail 24 within the segment controller. The terms positive and negative are used for reference herein and are not meant to be limiting. It is contemplated that the polarity of the DC voltage present between the input terminals 21, 23 may be negative, such that the potential on the negative rail 24 is greater than the potential on the positive rail 22. Each of the voltage rails 22, 24 are configured to conduct a DC voltage having a desired potential, according to application requirements. According to one embodiment of the invention, the positive rail 22 may have a DC voltage at a positive potential and the negative rail 24 may have a DC voltage at ground potential. Optionally, the positive rail 22 may have a DC voltage at ground potential and the negative rail 24 may have a DC voltage at a negative potential. According to still another embodiment of the invention, the positive rail 22 may have a first DC voltage at a positive potential with respect to the ground potential and the negative rail 24 may have a second DC voltage at a negative potential with respect to the ground potential. The resulting DC voltage potential between the two rails 22, 24 is the difference between the potential present on the positive rail 22 and the negative rail 24.

It is further contemplated that the DC supply may include a third voltage rail 26 having a third voltage potential. According to one embodiment of the invention, the positive rail 22 has a positive voltage potential with respect to ground, the negative rail 24 has a negative voltage potential with respect to ground, and the third voltage rail 26 is maintained at a ground potential. Optionally, the negative voltage rail 24 may be at a ground potential, the positive voltage rail 22 may be at a first positive voltage potential with respect to ground, and the third voltage rail 26 may be at a second positive voltage potential with respect to ground, where the second positive voltage potential is approximately one half the magnitude of the first positive voltage potential. With such a split voltage DC bus, two of the switching devices 74 may be used in pairs to control operation of one coil 150 by alternately provide positive or negative voltages to one the coils 150.

The power section in each segment controller 50 may include multiple legs, where each leg is connected in parallel between the positive rail 22 and the negative rail 24. According to the embodiment illustrated in FIG. 9, three legs are shown. However, the number of legs may vary and will correspond to the number of coils 150 extending along the track segment 12. Each leg includes a first switching device 74a and a second switching device 74b connected in series between the positive rail 22 and the negative rail 24 with a common connection 75 between the first and second switching devices 74a, 74b. The first switching device 74a in each leg may also be referred to herein as an upper switch, and the second switching device 74b in each leg may also be referred to herein as a lower switch. The terms upper and lower are relational only with respect to the schematic representation and are not intended to denote any particular physical relationship between the first and second switching devices 74a, 74b. The switching devices 74 include, for example, power semiconductor devices such as transistors, thyristors, and silicon-controlled rectifiers, which receive the switching signals 72 to turn on and/or off. Each of switching devices may further include a diode connected in a reverse parallel manner between the common connection 75 and either the positive or negative rail 22, 24.

The processor 52 also receives feedback signals from sensors providing an indication of the operating conditions within the power segment or of the operating conditions of a coil 150 connected to the power segment. According to the illustrated embodiment, the power segment includes a voltage sensor 62 and a current sensor 60 at the input of the power segment. The voltage sensor 62 generates a voltage feedback signal and the current sensor 60 generates a current feedback signal, where each feedback signal corresponds to the operating conditions on the positive rail 22. The segment controller 50 also receives feedback signals corresponding to the operation of coils 150 connected to the power segment. A voltage sensor 153 and a current sensor 151 are connected in series with the coils 150 at each output of the power section. The voltage sensor 153 generates a voltage feedback signal and the current sensor 151 generates a current feedback signal, where each feedback signal corresponds to the operating condition of the corresponding coil 150. The processor 52 executes a program stored on the memory device 54 to regulate the current and/or voltage supplied to each coil and the processor 52 and/or gate driver module 70 generates switching signals 72 which selectively enable/disable each of the switching devices 74 to achieve the desired current and/or voltage in each coil 150. The energized coils 150 create an electromagnetic field that interacts with the drive magnets 130 on each mover 100 to control motion of the movers 100 along the track segment 12.

In operation, the independent cart system is configured to identify movers 100 with a high priority and clear congestion along a desired route for the mover 100. According to one aspect of the invention, a majority of commanded traffic for the movers 100 may be set to a first priority level. The first priority level permits each mover 100 equal access to various track segments 12 and resources or stations positioned along the track 10. When a particular mover 100 is designated as a second, higher priority level, the independent cart system either clears other movers 100 from a desired route or creates a clear route along which the mover 100 with the higher priority level may travel. Optionally, the independent cart system may also be configured with more than two priority levels. The segment controllers 50 compare priority levels assigned to each mover 100 and alter motion commands for movers 100 having lower priority to permit movers 100 with higher priority to complete their desired route.

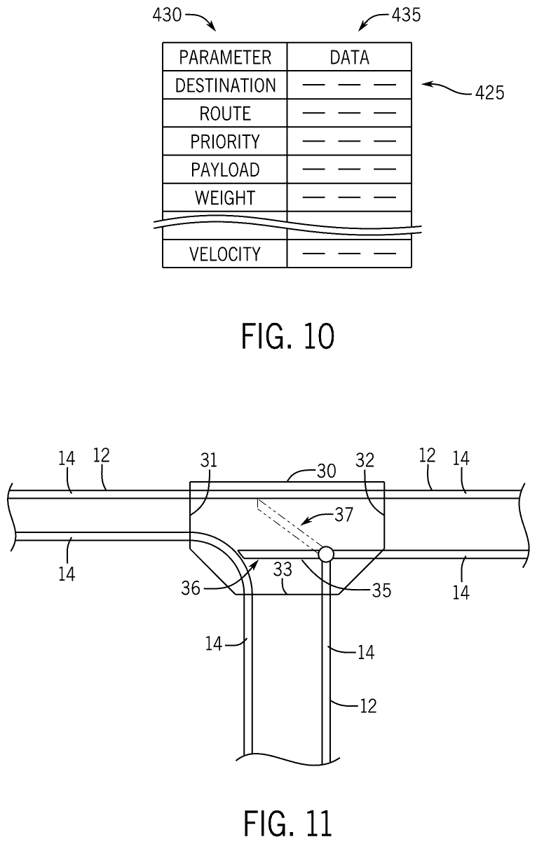

With reference next to FIGS. 9 and 10, each mover 100 may have a vehicle worksheet 425 assigned to the mover 100. The vehicle worksheets 425 include multiple parameters 430 and the data 435 associated with each parameter. According to the illustrated embodiment, the vehicle worksheet 425 stores a desired destination and route information for the mover 100. Each vehicle worksheet 425 also includes a parameter 430 identifying a priority of the mover 100 within the independent cart system and a payload to be received by the mover 100. The parameter may include either a single or multiple items of payload. For multiple payload items, the order in which the items are to be loaded onto the mover 100 may also be stored as well as the weight of each item. Still other data such as whether an item is fragile, perishable, and the like may be included as parameters. A single velocity value for the mover 100 may be stored, indicating a maximum velocity at which the mover may travel along the route. Alternately, multiple velocity values may be stored, where each velocity corresponds to an item of payload. The mover 100 may be limited in speed when a heavy item, a fragile item, a liquid item prone to spillage, or the like is loaded onto the mover 100. The illustrated vehicle worksheet 425 is exemplary only and is not intended to be limiting. A vehicle worksheet 425 may include additional parameters 430 and their corresponding data 435. Optionally, some of the illustrated parameters 430 may not be required for some movers 100.

The vehicle worksheet 425 is associated with each mover 100 and is stored on the segment controller 50 responsible for controlling operation of the mover 100. The segment controller 50 may include a table 55 of vehicle worksheets 425, where the table includes a mover identification 57 and a column 59 of worksheets 425. In some applications, multiple movers 100 may be present on a single track segment 12 and, therefore, the segment controller 50 may need to have worksheets 425 for each mover 100. In other applications, the table 55 may pre-allocate memory such that a look up table is ready to receive a vehicle worksheet 425 for each mover 100 as the mover 100 arrives at the track segment 12. In still other applications, the segment controllers 50 on which a mover 100 is located may transmit the vehicle worksheet 425 to a portion of or to each track segment 12 along the desired route assigned to the mover in order to permit the segment controller 50 for each track segment 12 along the desired route to anticipate the arrival of each mover 100.

According to another aspect of the invention, alternate methods of storing and transmitting route information for a mover 100 between segment controllers 50 may be utilized. The vehicle worksheet 425 is illustrated and will be utilized herein for convenience. Optionally, route information, a desired destination, priority levels of each mover 100, or the like may be stored in other structures or other forms memory 54 and transmitted as payload in data packets between segment controllers.

As discussed above, the edge controller 260 may act as a fleet controller and generate an initial route for each mover 100 to travel. The route may be dynamically generated as a function of a need within the controlled system. The need may be retrieval of a part from a warehouse, delivery of the part to a manufacturing floor, delivery of a sample to a station for testing, or the like. A mover 100 may be identified based on its present location, capacity, usage, or other such factors to fulfill the need. The initial route may be generated from the machine learning model and assigned to the mover 100. For distributed control of each mover 100, the fleet controller may generate a new vehicle worksheet 425 or populate an existing vehicle worksheet when a mover 100 is required to fulfill a need. If a new vehicle worksheet 425 is generated, the new vehicle worksheet 425 is transferred to the segment controller 50 on which the mover 100 is located and stored in memory 54. If an existing vehicle worksheet 425 is already present in memory 54, the existing vehicle worksheet is populated with the new route, destination, and other parameters required to fulfill the need. Once the vehicle worksheet 425 is generated or populated, the segment controllers 50 utilize the information in the vehicle worksheet to control the mover 100 as it fulfills the need in the independent cart system.

The segment controller 50 on which the mover 100 is initially located begins commanding the mover 100 to travel to a desired destination and/or along a desired route included in the vehicle worksheet. As a mover 100 transitions from one track segment 12 to the next, adjacent track segment, the segment controller 50 from the track segment on which the mover 100 was previously controlled transmits the vehicle worksheet 425 to the segment controller 50 for the adjacent track segment 12 which will next be responsible for controlling the mover 100. In this manner, the vehicle worksheet 425 is sequentially transmitted to adjacent segment controllers 50 as the mover 100 travels along the track, and each subsequent segment controller 50 utilizes the information in the vehicle worksheet 425 to control operation of the mover 100.

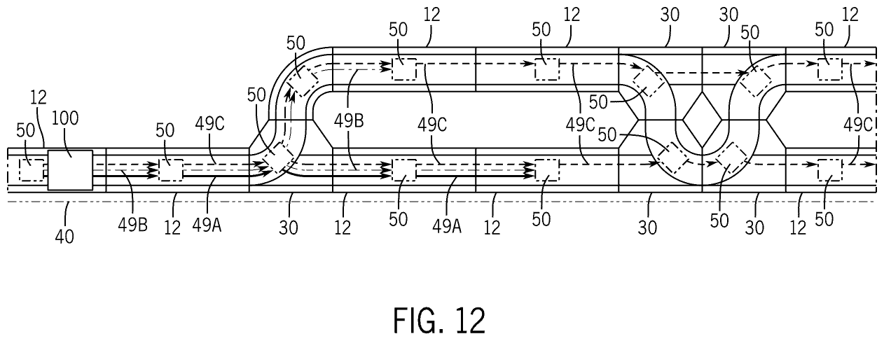

In addition to transmitting vehicle worksheets 425 as a mover 100 travels, a segment controller 50 may be configured to transmit a vehicle worksheet to multiple other segment controllers 50 in the independent cart system. With reference next to FIG. 12, an exemplary track for an independent cart system includes a single track extending off the left side of the figure. Moving from left to right with reference to FIG. 12, a first switch track segment 30 allows a mover 100 to travel along one of two parallel tracks for the remainder of the figure. With reference also to FIG. 11, one embodiment of a switch track segment 30 includes an arm 36 selectively positioned between a first position 35 and a second position 37. In the first position 35, the arm 36 directs a mover 100 to travel straight through the switch track segment 30 between an input 31 and a first output 32. In the second position 37, the arm 36 directs a mover 100 to travel around a bend on the switch track segment 30 between the input 31 and a second output 33. An actuator on the switch track segment 30 is controlled by the segment controller 50 for that switch track segment to move between the first and second positions 35, 37 according to the desired path 40 for a mover 100 commanded to travel across the switch track segment 30. The arm 36 requires a finite amount of time to transition between the first position 35 and the second position 37. Movers 100 may need to be spaced apart a sufficient distance to permit the arm 36 to transition between positions after one mover travels across the switch track segment and prior to another mover reaching the switch in order to permit the arm 36 to move between positions when two successive movers 100 are commanded to move along different paths. The illustrated arm is not intended to be limiting. Other switching mechanisms may be utilized to direct a mover 100 along different paths. For example, a pin or series of pins may extend and retract from the switch track segment 30 and engage a groove or grooves within the mover 100 to direct the movers 100 along a desired path. Similarly, electromagnets may be positioned along each path of the switch track segment 30 and magnetic receptive materials may be mounted on the movers. The electromagnets are then selectively activated to attract the magnetic receptive materials along one of the paths on the switch.

Referring again to FIG. 12, each parallel track includes a pair of straight track segments 12 before arriving at a set of switch track segments 30. The set of switch track segments 30 permits movers 100 to transition between each of the parallel tracks before continuing to travel to the right of the figure along one of the parallel tracks. A single mover 100 and a desired path 40 for the mover to travel is illustrated in FIG. 12. The first track segment 12, on which the mover 100 is located, transmits the vehicle worksheet 425 to multiple other segment controllers 50 prior to the mover 100 reaching the corresponding track segments 12, 30. According to one aspect of the invention, the first segment controller 50 is configured to transmit the vehicle worksheet to four segment controllers 50 along the desired route 40. A first arrow 49A indicates the communication path along which a data packet, including the vehicle worksheet 425, travels from the first segment controller 50 to each of the next four segment controllers 50 along the desired route 40. According to another aspect of the invention, the first segment controller 50 may be configured to transmit the vehicle worksheet to four segment controllers 50 along any route in the desired direction of travel. A pair of second arrows 49B indicates the communication path along both the desired route 40 and along the parallel track which a data packet containing the vehicle worksheet 425 travels from the first segment controller 50. The number of segment controllers to which the data packet is transmitted is not limited to four. The first segment controller 50 may transmit the data packet to fewer or to a greater number of segment controllers. Further, the desired number may be configurable and stored in memory 54 of the segment controller 50 during commissioning. If the desired destination is located at a greater distance from the first segment controller 50 than the number of segment controllers receiving the data packet, the final segment controller 50 receiving the initial communication may be configured to retransmit the data packet to an additional number of segment controllers 50 and so on until each segment controller 50 between the first segment controller and a segment controller located at the desired destination receives the data packet. According to still another aspect of the invention, the first segment controller 50 may be configured to transmit the vehicle worksheet to every segment controller 50 along the desired route 40, every segment controller 50 along each route between the first segment controller 50 and a destination, or as a broadcast message to every segment controller 50 in the independent cart system. A pair of third arrows 49C indicates a communication path along both the desired route 40 and along the parallel path which the data packet may travel in a broadcast message or along multiple routes between the first segment controller 50 and a segment controller present at a desired destination.

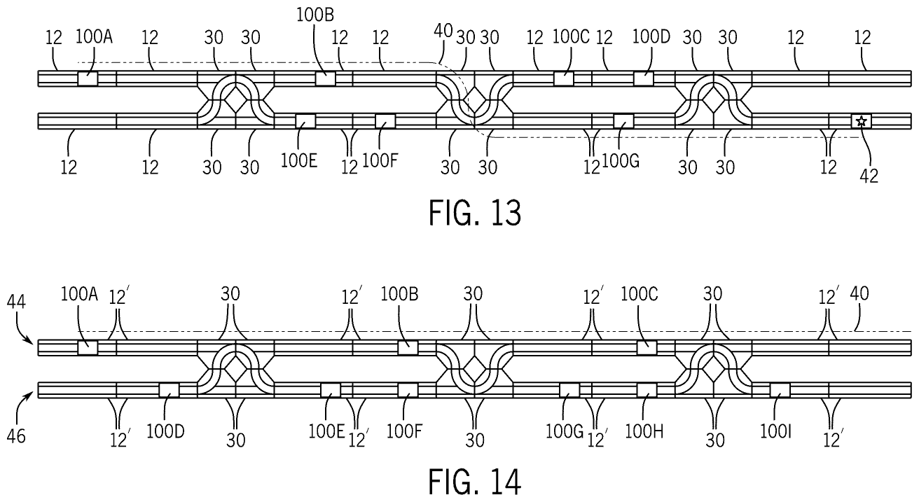

Turning next to FIG. 13, an exemplary track 10 includes a portion of track with two parallel paths. Each path includes multiple track segments 12 and sets of switch track segments 30 are spaced apart at intervals, allowing a mover 100 to transition between the two parallel paths. According to the illustrated embodiment, each mover 100 may be moving, awaiting a motion command, or temporarily holding a desired position next to a station adjacent to the track. The segment controller 50 for the track segment 12 on which the first mover 100A is located receives a motion command for the first mover 100A. A desired path 40 is illustrated from the present location of the first mover 100A to a destination 42. A priority level and a motion command for the first mover 100A is also provided to the segment controller 50. The motion command and priority level may be received in a vehicle worksheet 425. Optionally, a fleet controller may transmit a desired destination and/or a desired route and a desired priority level to the segment controller 50. The segment controller 50 may generate a vehicle worksheet 425 or populate an existing vehicle worksheet 425 with the information for the first mover 100A. As used herein, an object described by a reference numeral without a letter, such as a mover 100, refers to an object, or each instance of an object, generally. The object described by a reference numeral with a letter, such as a first mover 100A or a second mover 100B, describes a specific instance of an object.

For discussion, the segment controller 50 for the track segment on which the first mover 100A is located in the illustrated example will transmit the priority level and the destination of the first mover 100A to each of the other segment controllers 50 along the desired route 40 for the first mover 100A. A second mover 100B and a seventh mover 100G are located along the path. The segment controller 50 for the track segments on which the second and seventh movers 100B, 100G are located compare the priority level for the first mover 100A to a priority level for the second and seventh movers to determine which mover has the higher priority. If the first priority level is equal to or less than the priority level for the other two movers, no action is required. If the priority level for the first mover 100A is greater than the priority level for either the second mover 100B or the seventh mover 100G, the segment controller 50 on which the mover 100 is located is configured to issue a new command or change an existing command for the mover with a lower priority.

Each segment controller 50 is configured to modify a motion command for a mover 100 located on the track segment corresponding to the segment controller 50. This distributed control capability allows for dynamic modification of routes assigned to individual movers 100 in order to clear a route for a mover 100 assigned a higher priority. According to one aspect of the invention, the vehicle worksheet 425 includes a velocity at which the mover 100 travels. The segment controller 50 may utilize the velocity of the first mover 100A and the velocity of the second or seventh mover 100B, 100G, with a lower priority, to determine whether the mover with a lower priority will remain in the desired route 40 of the first mover 100A such that the lower priority mover interferes with the travel of the first mover 100A. For example, in FIG. 13, the second mover 100B may be commanded to continue travel in a straight direction along the upper track past the next set of switch track segments 30 while the desired route 40 of the first mover 100A transitions to the lower track. If the second mover 100B will clear the set of switch track segments 30 prior to the first mover 100A arriving, the segment controller 50 on which the second mover 100B is located permits the second mover 100B to continue travelling according to its commanded motion. If, however, the route for the second mover 100B includes a stop, for example, at a station within the desired route 40 or the velocity at which the second mover 100B is travelling interferes with the motion of the first mover 100A, the segment controller 50 on which the second mover 100B is located may command the second mover 100B to continue travelling along the upper path rather than stopping at a station or increase the speed at which the second mover 100B is travelling until the second mover 100B is out of the desired path. If the payload on the second mover 100B must still stop at the station which it is presently being commanded to bypass, the segment controller may generate a new motion command for the second mover 100B to travel along the track in a manner that will cause the second mover 100B to later return to the station it bypassed as a result of allowing a higher priority mover to continue along its desired route 40.

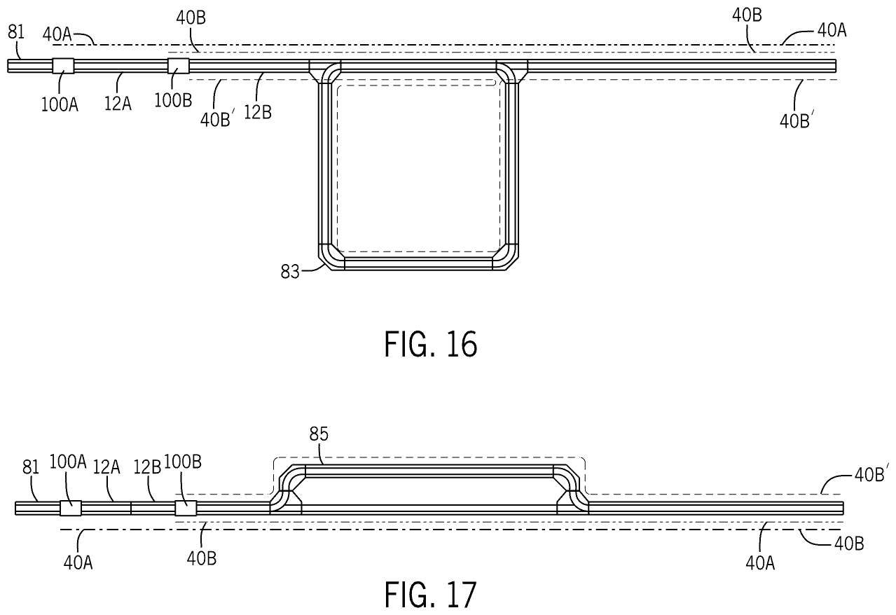

According to another aspect of the invention, the track may include a number of alternate routes along which a mover 100 may travel. Turning, for example to FIGS. 16 and 17, FIG. 16 illustrates a primary track 81 and a buffer zone 83, and FIG. 17 illustrates a primary track 81 and a bypass zone 85. The buffer zone 83 and the bypass zone 85 both provide alternate routes along which a mover 100 may travel but provide slightly different function. A buffer zone 83 creates a return path such that a mover 100 directed into the buffer zone 83 may return to an earlier position along the track. In this manner, if a mover 100 is commanded to skip a station along the primary track 81, the buffer zone 83 is configured to allow the mover 100 to return to an upstream position along the track and then resume travel to the desired station. With reference to FIG. 16, a segment controller 50 for the first track segment 12A includes a first desired route 40A for the first mover 100A to travel. The first segment controller communicates the desired route 40A and a first priority level for the first mover 100A to the segment controller 50 for the second track segment 12B. The second segment controller 50 has a priority level and a second desired route 40B stored for the second mover 100B. The second segment controller 50 compares the priority level for the first mover 100A to the priority level for the second mover 100B and determines that the first mover 100A has a greater priority level. The second segment controller 50 adjusts the desired route 40B for the second mover 100B to a modified route 40B′ which includes a loop around the buffer zone 83. While the second mover 100B is traversing the buffer zone 83, the first mover 100A continues travel along the primary track 81, passing the second mover 100B.

A bypass zone 85 provides a parallel travel route in the same direction of travel. If, for example, no station or other point of interaction offboard of the track exists along a length of the primary track 81, a mover 100 may transition to the bypass zone 85 and reduce speed. By travelling at a reduced speed, a mover 100 on the bypass zone 85 allows a faster travelling mover to pass along the primary track 81 while continuing to travel in the desired direction of travel. Once the mover 100 has passed on the primary track, the mover in the bypass zone 85 may return to the primary track 81 and continue travelling along its commanded route. With reference to FIG. 17, a segment controller 50 for the first track segment 12A includes a first desired route 40A for the first mover 100A to travel. The first segment controller communicates the desired route 40A and a first priority level for the first mover 100A to the segment controller 50 for the second track segment 12B. The second segment controller 50 has a priority level and a second desired route 40B stored for the second mover 100B. The second segment controller 50 compares the priority level for the first mover 100A to the priority level for the second mover 100B and determines that the first mover 100A has a greater priority level. The second segment controller 50 adjusts the desired route 40B for the second mover 100B to a modified route 40B′ which includes a transition to the bypass zone 85. In addition, the second segment controller 50 may modify the commanded speed at which the second mover 100B is to travel to slow down the rate at which the second mover 100B travels along the bypass zone 85. While the second mover 100B is traversing the bypass zone 85, the first mover 100A continues travel along the primary track 81, passing the second mover 100B.

Turning next to FIG. 14, one track configuration for the independent cart system may include a priority lane 44 and a secondary lane 46. The illustrated priority lane 44 and secondary lane 46 are arranged in parallel between two locations. Each lane includes multiple track segments 12 and sets of switch track segments 30, spaced apart at intervals, allowing a mover 100 to transition between the two parallel lanes. During normal operation, it is contemplated that movers 100 may be scheduled to travel along either lane 44, 46. As shown in FIG. 14, multiple movers are present on both the priority lane 44 and on the secondary lane 46. Using both lanes for movers 100 having the same priority level increases the overall throughput for those movers 100 within the independent cart system. On occasion, however, it may be necessary to have one mover designated as a high priority mover. In the illustrated embodiment, the first mover 100A receives a motion command and a priority level greater than the priority levels of each of the other movers 100B-100H in the system. The segment controller 50 for the first track segment 12A communicates the priority level as well as a desired route 40 or a destination for the first mover 100A to segment controllers 50 in other track segments 12′ and in switch track segments 30 along the priority lane 44, the secondary lane 46, or a combination thereof. As discussed above, the segment controller 50 for the first track segment 12A may be configured to transmit the priority level and desired route 40 to a portion of the other track segments 12′ and switch track segments 30 along the desired route 40 or in either lane 44, 46. Providing the information to a segment controller 50 in the secondary lane 46, for example, may cause the segment controller 50 to modify the desired route for one of the movers 100D-100I if the mover was commanded to transition to the priority lane 44 at some point and the mover has a lower priority than the first mover 100A. The segment controller 50 may modify the desired route to keep the mover 100D-100I on the secondary lane 46 at least until the first mover 100A has passed. As also illustrated in FIG. 14, a second mover 100B and a third mover 100C are presently travelling along the priority lane 44. The segment controller 50 for the first track segment 12A communicates with the segment controller 50 on each of the corresponding track segments 12′ on which the second mover 100B or third mover 100C is located. The segment controller 50 for each of these corresponding track segments 12′ modifies a desired route for the second mover 100B or third mover 100C to command the corresponding mover to transition to the secondary lane 46, clearing the priority lane 44 for the first mover 100A to follow its desired route 40.

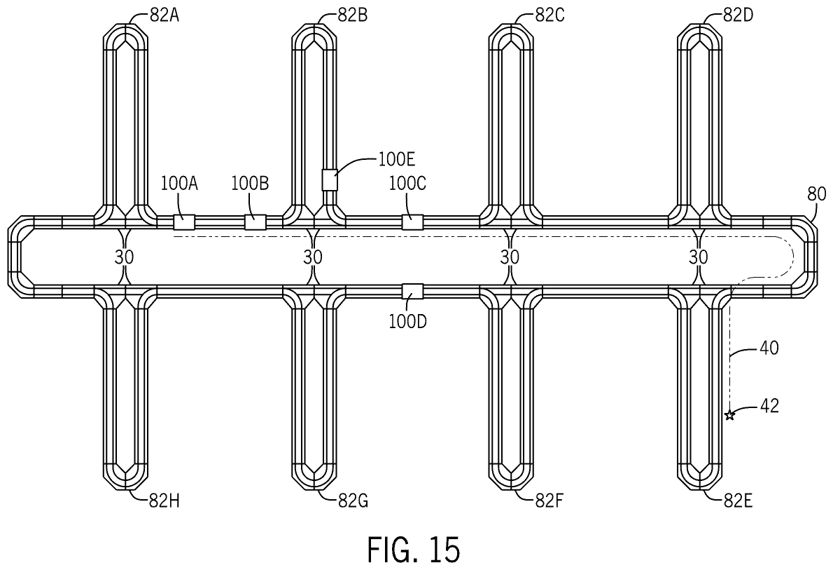

With reference now to FIG. 15, a track may include a main path 80 which loops back on itself and a number of side paths 82. Movers 100 may be configured to travel at a high rate of speed as they travel along the straight portions of the main path 80. However, switch track segments 30 require some time to transition between positions and a mover 100 may need to slow down to navigate the curve on to or off of one of the side paths 82. Therefore, movers 100 travelling along the main path 80 may need to slow or stop to wait for another mover 100 to transition from the main path 80 to one of the side paths 82 or to enter the main path 80 from one of the side paths 82. In the illustrated embodiment, the first mover 100A is assigned a higher priority than the other movers 100B-100E and receives a desired route 40 to travel from its present location to a desired destination 42 along the fifth side path 82E. The segment controller 50 for the track segment 12 on which the first mover 100A is located broadcasts the desired route 40 and/or the desired destination 42 of the first mover 100A to each of the other segment controllers 50. The segment controllers 50 for the track segments 12 on which the second, third, and fourth movers 100B-100D are located modify the present command for the respective movers to continue travelling around the main path 80 rather than exiting to any of the side paths 82. In this manner, none of the movers 100B-100D will cause an obstruction for the first mover 100A that would cause the first mover 100A to slow down prior to reaching the fifth side path 82E. Once the first mover 100A has exited the main path 80 to the fifth side path 82E, the segment controllers 50 for each of the new track segments 12 on which the movers 100B-100D are now located again modify the motion command for the corresponding movers to resume their prior commanded motion to the side path 82 they had originally been commanded.

According to another aspect of the invention, a switch track segment 30 may prevent a mover 100 with a lower priority from entering a desired path 40 of a mover with a higher priority. Using the track layout in FIG. 15, a fifth mover 100E is located on the second side path 82B. For purposes of discussion, the fifth mover 100E has a lower priority than the first mover 100A. Further, the fifth mover 100E has completed its task, or purpose, for travelling along the second side path 82B and is ready to renter the main path 80. However, the switch track segment 30 connecting the second side path 82B to the main path 80 has received the message from the track segment on which the first mover 100A is located that the first mover 100A has a higher priority than the fifth mover 100E and the first mover 100A needs to travel along the main path 80 past the second side path 82B to reach its desired destination 42. The switch track segment 30 sets its switch to a position that permits movers 100 to travel straight through the switch and prevents movers 100 from transitioning from the side path 82 to the main path 80. Further, the segment controller 50 on the track segment 12 on which the fifth mover 100E is located may also receive the message from the segment controller for the track segment on which the first mover 100A is located. According to one aspect of the invention, the segment controller for the track segment 12 on which the fifth mover 100E is located may temporarily modify the motion command for the fifth mover 100E to remain on the track segment until the first mover 100A has passed. According to another aspect of the invention, other control features, such as verifying that the switch track segment 30 has commanded its switch to the correct path prior to allowing a mover 100 to travel onto the switch track segment 30 may temporarily command the fifth mover 100E to stop its travel. After the first mover 100A has travelled through the switch track segment 30, the segment controller 50 for the switch track segment may control the switch to transition to the position to allow the fifth mover 100E to transition onto the main path 80. The segment controller 50 for the track segment 12 on which the fifth mover 100E is located may then restore the prior motion command for the mover. Alternately, the control feature that verifies that the switch track segment 30 is in the proper position may release the fifth mover 100E to allow the mover to resume travel along its desired path.

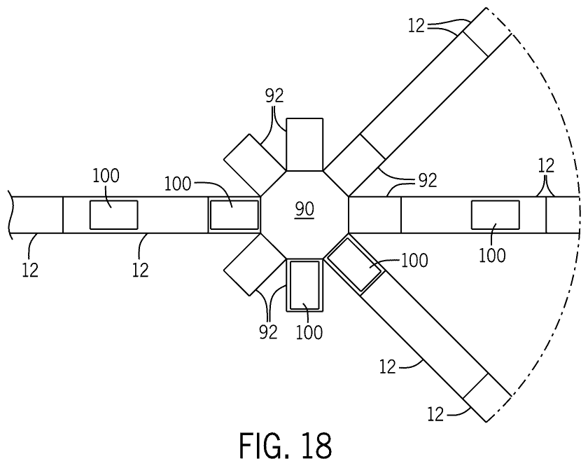

Turning next to FIG. 18, a rotary track segment 90 may be provided in the independent cart system. The rotary track segment 90 includes a plurality of switch stations 92 on which a mover 100 may reside. Each switch station 92 may or may not align with another track segment 12. The entire rotary track segment 90 is configured to rotate around a central axis, such that the switch stations 92 are selectively aligned with different track segments 12. According to the illustrated embodiment, it is contemplated that traffic may generally flow from left to right. In this instance, movers 100 arrive at the rotary track segment 90 and travel onto a switch station 92 facing to the left. The rotary track segment 90 may then rotate until the switch station 92 on which a mover 100 is located is aligned with one of the three track segments 12 to the right. The mover 100 may travel off of the rotary track segment 90 and continue travelling along any one of the three alternate paths. Although illustrated as a switch between multiple paths, a rotary track segment 90 may also be utilized next to an external station, where a processing step, a test, or other such activity external to the mover 100 interacts with the mover or a payload on the mover. As movers 100 arrive at the rotary track segment 90 they load on to the switch stations 92, and the rotary track segment 90 selectively positions one of the movers 100 where the processing step, test, or the like may be performed on the payload. Commonly, the external processing step, or delivery of a mover 100 to a desired exit track is performed on a first-in, first-out basis. If, however, a mover 100 with a higher priority is commanded to travel along a route with a rotary track segment 90 or to interact with an external station adjacent to the rotary track segment, the segment controller 50 for the rotary track segment 90 may first verify that there is a vacant switch station 92. If there is a vacant switch station 92, the rotary track segment 90 positions the vacant switch station 92 at the intake position for the mover 100 with high priority. The segment controller 90 delivers the high priority mover to its intended track or positions the high priority mover next the external station for processing out-of-order to its arrival. The segment controller 50 then commands the mover 100 to travel off of the rotary track segment 90. Any mover 100 present on the rotary track segment 90 may be commanded to remain on the rotary switch until the high priority mover transits through the rotary track segment 90 and normal processing of the movers 100 on the rotary switch resumes. If, however, there is no vacant switch station 92, the segment controller 50 for the rotary track segment 90 may first command a mover 100 present on the rotary track segment 90 to leave the rotary switch and travel to a position out of the desired path 40 for the high priority mover. Once the high priority mover 100 has transited through the rotary track segment 90 the mover 100 commanded to leave may return and continue its desired path.

Just as the segment controllers 50 are commanded to clear a path for a high priority mover 100, the segment controllers 50 may similarly maintain a clear path for the high priority mover. If another mover 100 is being controlled by a segment controller 50 which did not receive the message identifying a high priority mover and its intended route, when the segment controller 50, controlling operation of the low-priority mover 100 on one track segment 12, communicates with another segment controller 50, which is in the desired path and has received the communication regarding an incoming high priority mover, to transition the low-priority mover to the intended route, the segment controller 50 which had received the message, such as a segment controller 50 for a switch track segment 30, may prevent the low-priority mover 100 from entering the intended route. Thus, the segment controllers 50 may both clear and maintain a clear path for the high-priority mover.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A method for dynamic adaptation of a vehicle route in an independent cart system, comprising the steps of:
assigning a first priority level to a first mover in the independent cart system;
identifying a first destination for the first mover, wherein the first mover is located on a first track segment, the first destination is located on a second track segment, and a plurality of track segments are present between the first track segment and the second track segment;
transmitting the first priority level and the first destination from a first segment controller for the first track segment to a second segment controller for at least one of the plurality of track segments present between the first track segment and the second track segment;
receiving the first priority level at the second segment controller for a corresponding track segment on which a second mover is located;
comparing the first priority level to a second priority level for the second mover at the second segment controller; and
when the first priority level is greater than the second priority level, commanding the second mover to transition to at least one track segment other than the plurality of track segments present between the first track segment and the second track segment.

2. The method of claim 1, wherein:
an alternate route exists for the second mover to reach a second destination for the second mover, and
the step of commanding the second mover to transition to the at least one track segment other than the plurality of track segments present between the first track segment and the second track segment further comprises the step of commanding the second mover to the alternate route.

3. The method of claim 1, wherein:
a buffer zone including at least one track segment exists between the corresponding track segment and the first destination, and
the step of commanding the second mover to transition to the at least one track segment other than the plurality of track segments present between the first track segment and the second track segment further comprises the step of commanding the second mover to the buffer zone until the first mover passes the second mover.

4. The method of claim 1, wherein:
the corresponding track segment on which the second mover is located is a rotary track segment, and
the step of commanding the second mover to transition to the at least one track segment other than the plurality of track segments present between the first track segment and the second track segment further comprises the steps of:
verifying at least one position in the rotary track segment is vacant; and
commanding the second mover to remain in a present position on the rotary track segment until the first mover passes the second mover.

5. The method of claim 1, wherein:
the independent cart system includes a looping main path and a plurality of side paths,
the second mover is present on the looping main path, and
the step of commanding the second mover to transition to the at least one track segment other than the plurality of track segments present between the first track segment and the second track segment further comprises the step of commanding the second mover to continue travelling along the looping main path until the first mover has exited the looping main path to one of the plurality of side paths.

6. The method of claim 1, wherein:
the plurality of track segments include a priority lane and a secondary lane,
at least one switch track segment connects the priority lane and the secondary lane,
the plurality of track segments present between the first track segment and the second track segment include the priority lane,
the second track segment is present in the priority lane, and
the step of commanding the second mover to transition to the at least one track segment other than the plurality of track segments present between the first track segment and the second track segment further comprises the step of commanding the second mover to a track segment in the secondary lane.

7. The method of claim 1 wherein the independent cart system includes at least one switch track segment along a route between the first track segment and the second track segment, the method further comprising the step of setting the switch track segment to a position to allow the first mover to travel the route while preventing another mover from entering the route.

8. The method of claim 1 wherein:
the independent cart system includes at least one switch track segment along a route between the first track segment and the second track segment, and
the second mover is present along the route, the method further comprising the steps of:
setting the switch track segment to a first position to cause the second mover to exit the route, and
when the second mover has exited the route, setting the switch track segment to a second position to permit the first mover to travel along the route.

9. The method of claim 1, wherein:
the step of transmitting the first priority level and the first destination from the first segment controller for the first track segment to the second segment controller further comprises transmitting a broadcast message from the first segment controller to each segment controller in one of the plurality of track segments present between the first track segment and the second track segment;
each segment controller in one of the plurality of track segments present between the first track segment and the second track segment compares the first priority level to another priority level for another mover present on the corresponding track segment; and
each segment controller commands the other mover present on the corresponding track segment to clear a route between the first track segment and the second track segment.

10. A system for dynamic adaptation of a vehicle path in an independent cart system, the system comprising:
a first track segment, selected from a plurality of track segments defining a track for the independent cart system;
a first mover present on the first track segment;
a first segment controller for the first track segment, wherein the first segment controller is configured to control motion of the first mover while it is present on the first track segment;
a second track segment, selected from the plurality of track segments defining the track for the independent cart system;
a second mover present on the second track segment; and
a second segment controller for the second track segment, wherein the second segment controller is configured to control motion of the second mover while it is present on the second track segment and the second segment controller is in communication with the first segment controller, wherein:
the first segment controller has a first priority and a first destination for the first mover,
the first segment controller transmits the first priority and the first destination to the second segment controller,
the second segment controller compares the first priority to a second priority for the second mover, and
when the first priority level is greater than the second priority level, the second segment controller modifies an existing route commanded for the second mover to allow a clear route for the first mover to travel to the first destination.

11. The system of claim 10 further comprising:
an alternate route for the second mover to reach a second destination for the second mover, wherein the second segment controller modifies the existing route by commanding the second mover to travel along the alternate route.

12. The system of claim 10 further comprising:
a buffer zone including at least one track segment between the second track segment and the first destination, wherein the second segment controller modifies the existing route by commanding the second mover to the buffer zone until the first mover passes the second mover.

13. The system of claim 10 further comprising:
the second track segment on which the second mover is located is a rotary track segment, wherein the second segment controller modifies the existing route by:
verifying at least one position in the rotary track segment is vacant; and
commanding the second mover to remain in a present position on the rotary track segment until the first mover passes the second mover.

14. The system of claim 10 wherein:
the track includes a looping main path and a plurality of side paths,
the second mover is present on the looping main path, and
the second segment controller modifies the existing route by commanding the second mover to continue travelling along the looping main path until the first mover has exited the looping main path to one of the plurality of side paths.

15. The system of claim 10, wherein:
the track includes a priority lane and a secondary lane,
at least one switch track segment connects the priority lane and the secondary lane,
the first mover is commanded to travel to the first destination along the priority lane,
the second track segment is present in the priority lane, and
the second segment controller modifies the existing route by commanding the second mover to the secondary lane.

16. The system of claim 10 further comprising:
a switch track segment; and
a switch segment controller for the switch track segment, wherein:
the switch track segment is present along a route between the first track segment and the first destination,
the first segment controller transmits the first priority and the first destination to the switch segment controller, and
the switch segment controller is operative to set the switch track segment to a position to allow the first mover to travel the route while preventing another mover from entering the route.

17. The system of claim 10 further comprising:
a switch track segment; and
a switch segment controller for the switch track segment, wherein:
the switch track segment is present along a route between the first track segment and the first destination,
the first segment controller transmits the first priority and the first destination to the switch segment controller,
the second mover is present along the route,
the switch segment controller is operative to set the switch track segment to a first position to cause the second mover to exit the route, and
when the second mover has exited the route, the switch segment controller is operative to set the switch track segment to a second position to permit the first mover to travel along the route.

18. A method for dynamic adaptation of a vehicle route in an independent cart system, comprising the steps of:
assigning a first priority level to a first mover in the independent cart system;
generating a first route for the first mover to reach a destination, wherein the first route includes a plurality of track segments for the independent cart system along which the first mover will travel;
providing the first route and the first priority level to a first segment controller for one of the plurality of track segments on which the first mover is located;
transmitting the first priority level and the first route to at least one additional segment controller for another track segment along the first route;
receiving the first priority level for the first mover at a second segment controller for one of the plurality of track segments on which a second mover is located;
comparing the first priority level to a second priority level for the second mover at the second segment controller;
comparing a second route for the second mover to the first route with the second segment controller when the first priority level is greater than the second priority level; and
adjusting the second route to allow the first mover to travel along the first route when the first priority level is greater than the second priority level and when the second route interferes with the first route.

19. The method of claim 18 wherein:
an alternate route exists for the second mover to reach a second destination for the second mover, and
the step of adjusting the second route to allow the first mover to travel along the first route when the first priority level is greater than the second priority level and when the second route interferes with the first route further comprises the step of commanding the second mover to the alternate route.

20. The method of claim 18, wherein:
the step of transmitting the first priority level and the first route to the at least one additional segment controller for the other track segment along the first route further comprises transmitting a broadcast message from the first segment controller to each segment controller in one of the plurality of track segments present along the first route;
each segment controller in one of the plurality of track segments along the first route compares the first priority level to another priority level for another mover present on the corresponding track segment; and
each segment controller commands the other mover present on the corresponding track segment to clear the first route.
